(19) United States
(12) Patent Application Publication
(10) Pub. No.: US 2007/0219775 A1
(43) Pub. Date: Sep. 20, 2007

(54) Phrase translation and language instruction system

(76) Inventor: Jonathan Peter Smith, Santa Barbara, CA (US)

Correspondence Address: Jonathan Smith, 920 East Haley Street, Santa Barbara, CA, 93103-2543, US

(21) Appl. No.: 11/205,509

(22) Filed: Aug. 16, 2005

(51) Int. Cl. G06F 17/28

(52) U.S. Cl. 704/4

(57) ABSTRACT

A phrase translation and language instruction system is provided comprising a plurality of printed sheets having disposed thereupon information relating to the translation of certain generic phrases. Additionally, there is provided therein a set of alternative verbs, nouns, adjectives and the like to enable the substitution of words relating to one's specific situation and the communication of such in a foreign language.

### BACKGROUND OF THE INVENTION

1. Field of the Invention

The present invention generally relates to language translation systems. More particularly, the present invention relates to language learning systems. Even more particularly, the present invention relates to a combined language translation/learning system.

2. Description of Related Art

There exists a wide variety of both language learning systems and language translation systems. The distinct needs behind the use of such systems has driven the development of such in a divergent fashion. Notably, one finds that translation systems are geared towards the immediate phrase translation, idiomatic or otherwise. Conversely, one finds that language learning systems provide explanations as to grammar, syntax, pronunciation, tense and the like, but that such systems are not designed to immediately have one engaging in the type of conversations one might have using a translation system.

Language learning systems may include audio cassettes, cds, or computer software, as well as written materials, setting out basic linguistic rules and audio examples of pronunciation and language use. One is expected to “pick up” the idiomatic use of the language once one has learned the fundamentals.

Translation systems are not directed at “formally” learning a selected language and as such one finds phrase books that are filled with a wide variety of phrases categorized by subject, or the like. One generally finds the use of such phrase books difficult, given the wide variety of categorization systems and the vast number of phrases, any of which might, or might not be included in a given phrase book.

Alternatively, one finds a wide variety of electronic translation devices into which one might type a phrase and the phrase, translated into a selected language, is displayed onto a screen. Speech recognition and speech synthesis technologies have been introduced to aid one in the use of such devices as well and now one finds devices equipped with the capability to translate and speak aloud phrases.

While translation systems are being devised that are more and more user friendly, they fail to teach the structure behind the language into which one's phrases are translated. As such, there remains a void between language teaching systems and language translation systems. Therefore, what is needed in the art is a device and system that aids one in translating phrases while simultaneously serving to teach one the proper use of the language into which one is translating such phrases.

### SUMMARY OF THE INVENTION

It is to the solution of the hereinabove mentioned problems to which the present invention is directed. In accordance with the present invention there is provided a phrase translation and language instruction system comprising:

at least one page having generic phrases disposed thereupon wherein certain generic terms contained in said generic phrases are color coded;

at least one page having a plurality of color-coded words printed thereupon, wherein words having a color matching the color of a generic term contained in a generic phrase may be substituted for said generic term.

The present invention is a system for translating phrases and at the same time learning the basics of a new language. By using the language the way it was meant to be used from the very beginning, novices generate proper usage techniques and as such more proficiently learn to speak the language.

To enable such, a list of generic phrases, with their generic terms are provided on a printed sheet of material. Substitute words that may replace the generic terms are color coded to match the terms and thus enable a user to expand their use of the system. The pages may be protected by some additional material to make the material easier to handle and more durable as well.

For a more complete understanding of the present invention, reference is made to the following detailed description and accompanying drawings. In the drawings, like reference characters refer to like parts, in which:

### BRIEF DESCRIPTION OF THE DRAWINGS

FIG. 1 is a front perspective view of a phrase translation and language instruction system in accordance with a preferred embodiment of the present invention;

FIG. 2 is a rear perspective view of a phrase translation and language instruction system in accordance with a preferred embodiment of the present invention;

FIG. 3 is a rear plan view of two pages of a phase translation and language instruction system in accordance with the present invention; and

FIG. 4 is a rear plan view of two pages of a phase translation and language instruction system in accordance with the present invention.

### DESCRIPTION OF THE PREFERRED EMBODIMENTS

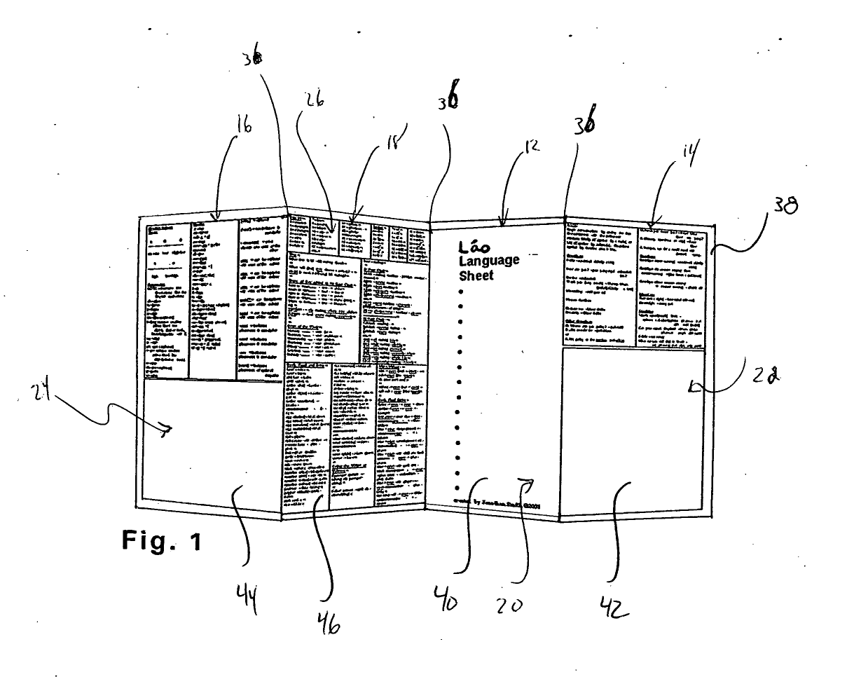

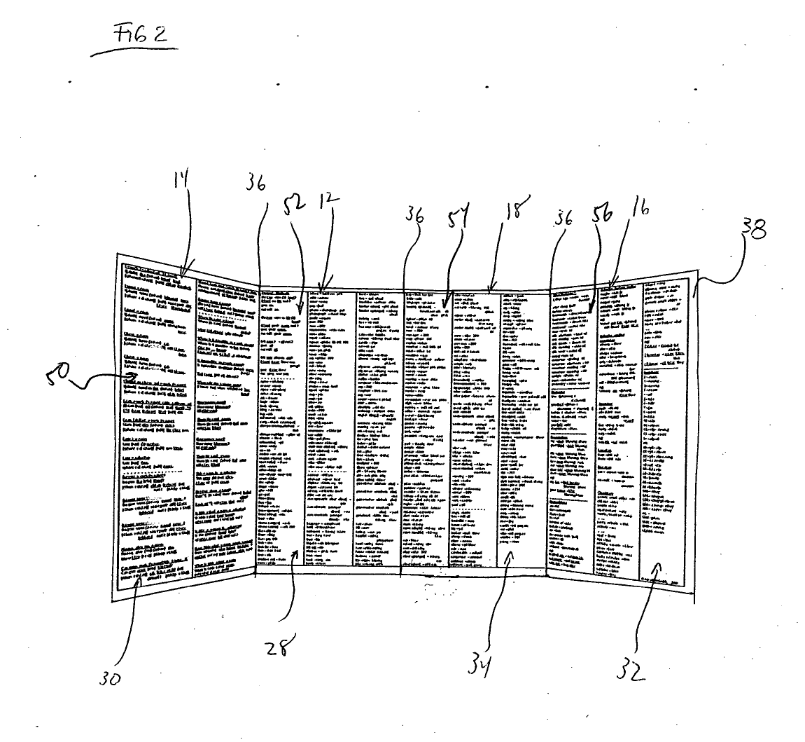

Referring to the drawings more particularly by reference numbers, FIGS. 1 and 2 show a preferred embodiment of the present system 10. The system 10 comprises a plurality of pages 12, 14, 16, 18. More particularly, and as depicted in FIG. 1, each of said pages has a front side 20, 22, 24, 26 and as depicted in FIG. 2, each of said pages has a corresponding rear side 28, 30, 32, 34. Each of said pages 12, 14, 16, 18 is positioned in a side-by-side relation to at least one other page. The present system 10 is preferably to translate from English into another languages. The system 10 is used by a user in a page-by-page fashion. The user may access pages 12, 14, 16 and 18 in the specific order presented in the formation of phrases.

The front side 20 of page 12 is referred to hereinbelow as the cover page 40. The front side 22 of page 14 is referred to herein as the first page 42. The front side 24 of page 16 is referred to herein as the second page 44 and the front side 26 of page 18 is referred to herein as the third page 46.

The rear side 30 of page 14 is referred to hereinbelow as the fourth page 50. The rear side 28 of page 12 is referred to herein as the fifth page 52. The rear side 34 of page 18 is referred to herein as the sixth page 54 and the rear side 32 of page 16 is referred to herein as the seventh page 56.

The pages 12, 14, 16, 18 may be formed from a single sheet of material, such as a single sheet of paper, cardboard, or some other similar material known to those skilled in the art. Alternatively and preferably, the present invention may be formed from a plurality of separate pages. A laminating layer 38 encompasses the pages 12, 14, 16, 18 to provide protection from moisture, frequent handling and to provide a wipeable and substantially disinfectable surface. Given that a system in accordance with the present invention has particularly useful value when used while traveling, providing the preferred embodiment presented herein presents the advantage that it might be disinfected if handled by multiple persons. Additionally, the lamination provides for additional durability of the embodiment as it is being carried and used by a user.

A crease 36 may be formed in the laminating layer 38 along a line 36 that defines the joining of two pages. A small gap may be emplaced between each of the pages 12, 14, 16, 18 to enable easier creasing, or folding of the lamination 38.

The cover page 40 includes an indicia of the language into which translation may be made. In the preferred embodiment presented, the language is Thai. It is to be appreciated that any language may be substituted for Thai and that while certain minor modifications might be incorporated into the use of the present system for languages other than Thai, the present system will serve to usefully translate phrases while at the same time teach the proper use of the selected language.

The first page 42 comprises a set of commonly used idiomatic phrases such as “Hello” and “How are you?” Additionally, the first page 42 may comprise phrases related to saying “Goodbye”, asking for directions and indicating to others in the selected language that one is or isn't able to easily speak the language. These phrases then, are the fundamental, or foundationally required phrases one might use as one begins to speak the language while traveling or working in the country in which the language is spoken and generally cannot be manipulated to create further phrases.

The second page 44 comprises a basic pronunciation guide and the rule-set for using a system as set out herein. While the rule-set might be placed on a different page, placing such on the second page 44 helps to ensure that the rules for use are reviewed often such that a user commits them to memory. Pronunciation rules include sounds for consonants and vowels and the indication of any tones that are central to a given language, as well as other variations in pronunciation thereof. Rules that are not essential to basic pronunciation as set out in the preferred embodiment may be included on a separate page.

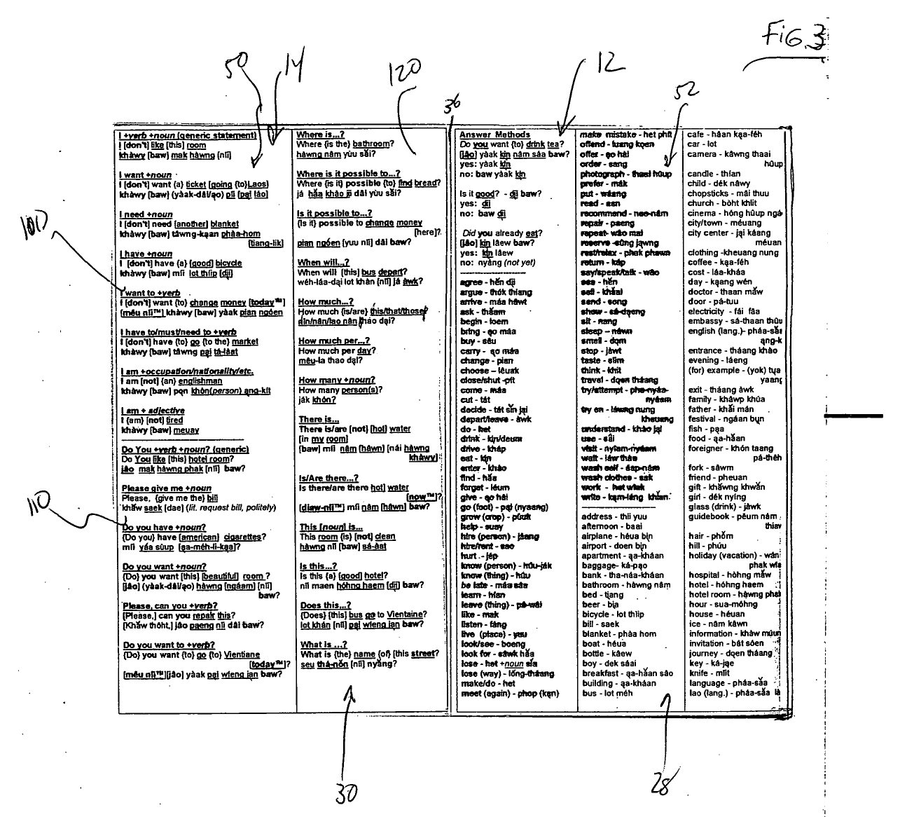

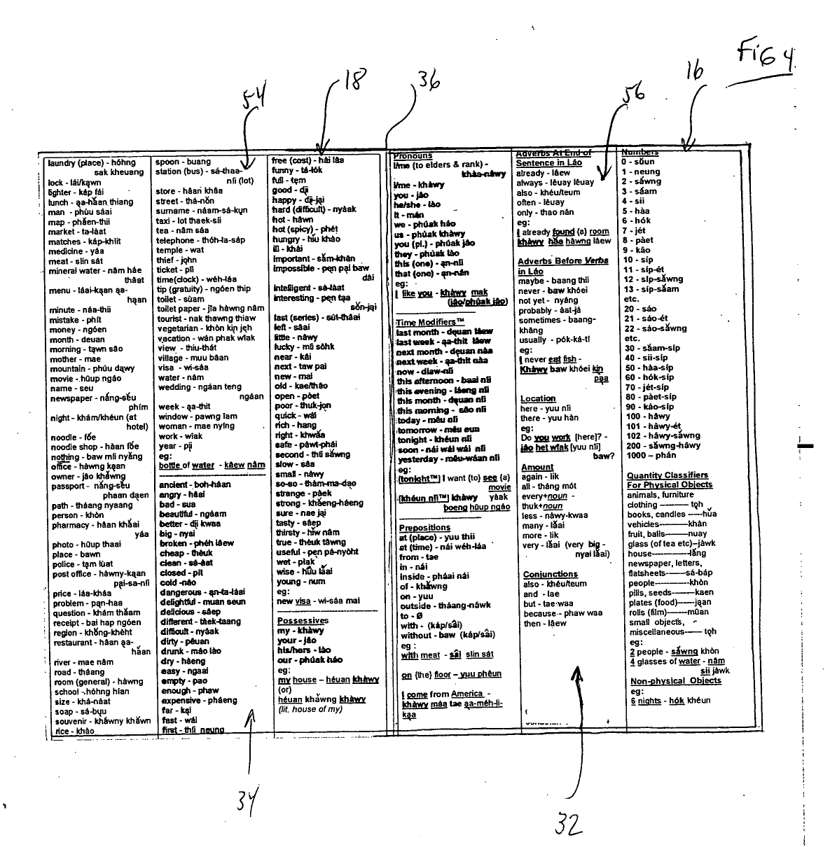

The rules of use include indications that bracketed words [for example] are optional, {words} are not included in the translation, (word/word) specifies that one of the words must be chosen, but not both. Additionally, and as shown in FIGS. 3 and 4, words are color-coded and underlined where words of a specific color may be replaced by a word of the same color. An underlined word of a specific color may be replaced by another word of the same color located on a page. It is to be additionally appreciated that many of the phrases included in the preferred embodiment of the present invention may be negated through the inclusion of a bracketed term as indicated in FIG. 3 nearly doubling the number of phrases that can be made with the preferred embodiment of the present invention. Additionally, a word may be printed in boldface in both the English and the translation to enable a user to more easily distinguish an English word and it's translation within a sentence.

The third page 46 may include words relating to specific categories including numbers, time related words such as clock time and days of the week and months in the year. Additionally, the categories of food and drinks, and food styles may be provided. Pages 42 and 44 include space for personalized inclusion of selected additional idiomatic phrases.

The fourth, fifth, sixth and seventh pages 50, 52, 54, 56 comprise the remainder of the system 10. As depicted in FIG. 3, the fourth page 50 comprises two columns and three groups. A first group 100 comprises first person statements such as “I want . . . ”, “I have . . . ” A second group 110 comprises second person in nature, such as “Do you . . . ”, or “Please, can you . . . ” The third group is comprised of generic questions and statements that have been found to be useful when one is traveling such as questions concerning: how much, location, quantity, identity and function. Again, one finds such depicted in FIG. 3.

The fifth page 52 preferably comprises a depiction as to how questions are answered. Following this and as depicted in FIGS. 3 and 4, the remainder of the fifth page 52 and the sixth page 54 comprise lists of words that can be used to alter the sample sentences set out on the other pages. Such lists include verbs, nouns, adjectives, possessives, pronouns, time modifiers, prepositions, and adverbs. Additional categories such as words depicting amount, are also included on the sixth page.

In essence, the system 10 leads one gently into the use of a foreign language. It aids one in establishing the general rules of basic grammar and syntax while at the same time providing one the flexibility to create new phrases on the fly and grow in the knowledge of the language.

While certain exemplary embodiments of the present invention have been described and shown on the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. As such, what is claimed is:

1. A phrase translation and language instruction system comprising:
at least one page having generic phrases disposed thereupon wherein certain generic terms contained in said generic phrases are color coded;
at least one page having a plurality of color-coded words printed thereupon, wherein words having a color matching the color of a generic term contained in a generic phrase may be substituted for said generic term.

2. The phrase translation and language instruction system of claim 1 wherein each of said at least one pages is laminated.

3. The phrase translation and language instruction system claim 1 wherein said generic terms comprise verbs, nouns and adjectives.

4. The phrase translation and language instruction system of claim 1 wherein at least one of said color-coded words is underlined.

5. The phrase translation and language instruction system of claim 1 wherein at least one of said color-coded words is displayed with a boldface type.

6. The phrase translation and language instruction system of claim 1 wherein at least one of said color-coded words is bracketed.

7. The phrase translation and language instruction system wherein said at least one page is configured to seat within a pant pocket.

8. The phrase translation and language instruction system claim 1 wherein said system is used in a page by page fashion.

9. The phrase translation and language instruction system of claim 1 comprising white space for user included terms.

10. The phrase translation and language instruction system of claim 4 wherein at least one of said color-coded words is displayed with a boldface type.

11. The phrase translation and language instruction system of claim 4 wherein at least one of said color-coded words is bracketed.

12. The phrase translation and language instruction system claim 1 wherein said user adds terms to said system.

13. A method for using a phrase translation and language instruction system, said method comprising the steps of:
a. accessing the 1^{st} page of the system;
b. accessing the 2^{nd} page of the system;
c. accessing the 3^{rd} page of the system; and
d. accessing the 4^{th} page of the system.
